(19) United States
(12) Patent Application Publication
(10) Pub. No.: US 2016/0232043 A1
(43) Pub. Date: Aug. 11, 2016

(54) GLOBAL CACHE FOR AUTOMATION VARIABLES

(71) Applicant: James R. Malnati, Stillwater, MN (US)

(72) Inventor: James R. Malnati, Stillwater, MN (US)

(73) Assignee: Unisys Corporation, Blue Bell, PA (US)

(21) Appl. No.: 14/618,258

(22) Filed: Feb. 10, 2015

(51) Int. Cl. G06F 9/54; G06F 11/07

(52) U.S. Cl. CPC G06F 9/542; G06F 11/0793; G06F 11/0721

(57) ABSTRACT

A global cache of automation variables may be established for a computing environment. Message event reports may be received and parsed at an application manager. Based on the message event report, variables may be stored in a global cache for use by several different disparate computer systems executing different operating systems. If a system reboot or failure occurs, the variables may be retrieved from the global cache and transmitted to the required systems to restore operations.

### FIELD OF THE DISCLOSURE

The instant disclosure relates to data management. More specifically, this disclosure relates to the storing and retrieving global variables for multiple computing systems.

### BACKGROUND

Variables are used in computing systems for storing data. For example, variables may include counters for number of files downloaded, event logs storing data about events occurring within computer hardware or computer software, and/or a computer's internet protocol (IP) address. These variables are conventionally stored on databases that are local to the particular computing system that makes use of the variable. For example, a computing system that manages shipping invoices and air waybills may utilize several variables associated with invoices and air waybills, such as the cost of the shipment, the shipper's name, or the destination of the shipment. In more complex programming applications, environment variables are invoked by computing systems to maintain performance or perform critical tasks essential to the operation of a computing system.

Software executing on computing systems has evolved to make use of the myriad of information stored within these variables. In fact, many computing systems implement automation rules that allow an administrator or user to program rules that cause certain actions to occur automatically based on data within the variables. For example, an action may be taken when a computer's IP address changes. Using rules to define events to be detected and actions to be taken in response to the defined events allows a computing system to operate at least partially autonomously without an administrator or user monitoring the computing system 24/7. However, one drawback is that the automation rules only have access to information stored in variables local to the computing system executing the automation rules.

### SUMMARY

As business operations become more global, administrators and users benefit from computing systems that are compatible with other systems and environments. Compatibility includes the ability to access information, including variables, from other systems when needed. Some operating systems, such as UNISYS OS2200 and Master Control Program (MCP), possess automation languages that operate at the server level. Automation languages involve the correlation of events across multiple operating systems that are significantly different from each other. Presenting information, such as variables, from many different computing systems to the automation language improves the level of automation capable and improves the intelligence of the computer system being automated.

Additionally, interoperability and compatibility between computer systems of different types, or disparate computer systems, reduces the likelihood that the threat of a computer system or operating system failure occurring or decreases the time that the failure affects the computer system. If a system is making use of a particular variable, that variable may contain a computed or assigned value. When a failure occurs in a computer system, such as within an operating system executing on the computer system, the variable may be lost in the failure, and other operating systems that make use of that variable may lose access to it, thus impeding the operation of the other operating system. If the variable is a global variable, the variable itself may not be lost, but the state of the variable, such as its value, may not be retained.

Global caches described herein may allow synchronizing events between different computer systems to coordinate when processing occurs and where it occurs. Global caches may also allow retention of hardware device states. While a system is running, its discrete components may be, for example, up, down, or reserved. When the system is rebooted these device states may be lost and may need to be reestablished later through system console commands. With a global variable cache these device names and states may be saved for later use.

A message system may implement a message event report, which may be received from an application manager that is coupled to or communicates with the operating system. The message event report may contain several pieces of information including variables and variable states. By utilizing application programming interfaces (APIs), a system may send messages to the message system for parsing based on a set of parsing rules. One of the parsing rules may include instructions for the message system to store variables of the operating systems so that they may be later accessed by other systems, thus establishing a global cache of automation variables. The variables stored in the global cache may be used for event correlation and for other purposes defined by separate automation rules.

An application manager may be adapted to receive attribute change event reports from operating systems and transmit message event reports to the message system. Upon receiving the message event report, the message system may store variables in a global cache of automation variables. This adaptation of the application manager may present a new approach that allows all operating systems the ability to send message event reports to the message system because in the past, only some operating systems were equipped with this capability. Using a global cache of automation variables may allow events to be synchronized between managed systems. Global caches may also allow information, including variables, to be shared across different operating system platforms. In addition, global caches may allow hardware device and variable states to be retained in the event that the system is rebooted or has experienced a failure. If the system is rebooted, device states may typically be lost and may need to be reestablished at a later time through system console commands. With a global cache, these device names and states may be quickly retained and implemented by the system.

According to one embodiment, a method may include receiving one or more message event reports from an application manager; parsing the one or more message event reports in accordance with established parsing rules; and storing one or more variables and their most recent variable states associated with the one or more operating systems in a primary global cache. In response to a failure of one of the one or more operating systems, the method may further include retrieving the one or more variables and their most recent variable states from the primary global cache and transmitting the one or more variables and their most recent variable states to the application manager, wherein the application manager is configured to transmit the one or more variables and their most recent variable states to the one or more failed operating systems.

According to another embodiment, an apparatus may include a processor and a memory coupled to the processor. The processor may be configured to perform the steps of receiving one or more message event reports from an application manager, parsing the one or more message event reports in accordance with established parsing rules; and storing one or more variables and their most recent variable states associated with the one or more operating systems in a primary global cache. In response to a failure of one of the one or more operating systems, the processor may be further configured to perform the steps of retrieving the one or more variables and their most recent variable states from the primary global cache and transmitting the one or more variables and their most recent variable states to the application manager, wherein the application manager is configured to transmit the one or more variables and their most recent variable states to the one or more failed operating systems.

According to a further embodiment, a computer program product may include a non-transitory computer readable medium containing instructions which, when executed by a processor of a computing system, cause the processor to receive one or more message event reports from an application manager; parse the one or more message event reports in accordance with established parsing rules; and store one or more variables and their most recent variable states associated with the one or more operating systems in a primary global cache. In response to a failure of one of the one or more operating systems, the non-transitory computer readable medium of the computer program product may further include instructions which, when executed by the processor of the computing system, cause the processor to retrieve the one or more variables and their most recent variable states from the primary global cache and transmit the one or more variables and their most recent variable states to the application manager, wherein the application manager is configured to transmit the one or more variables and their most recent variable states to the one or more failed operating systems.

The foregoing has outlined rather broadly the features and technical advantages of the present invention in order that the detailed description of the invention that follows may be better understood. It is first noted here that the terms “transaction” and “action” may be synonymous throughout this disclosure. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a limitation of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is an illustration of a computing environment detailing how information is stored and shared between operating systems according to one embodiment.

FIG. 2 is a flowchart illustrating a method of saving variables in a global cache according to one embodiment.

FIG. 3 is a flowchart illustrating a method of retrieving variables from a global cache in response to a system failure according to one embodiment.

FIG. 4 illustrates a method of storing and retrieving variables by a message system according to one embodiment.

FIG. 5 illustrates one embodiment of a system for transferring information, including a system for establishing a global cache according to one embodiment.

FIG. 6 illustrates a computer system adapted according to certain embodiments of the server and/or the user interface device.

### DETAILED DESCRIPTION

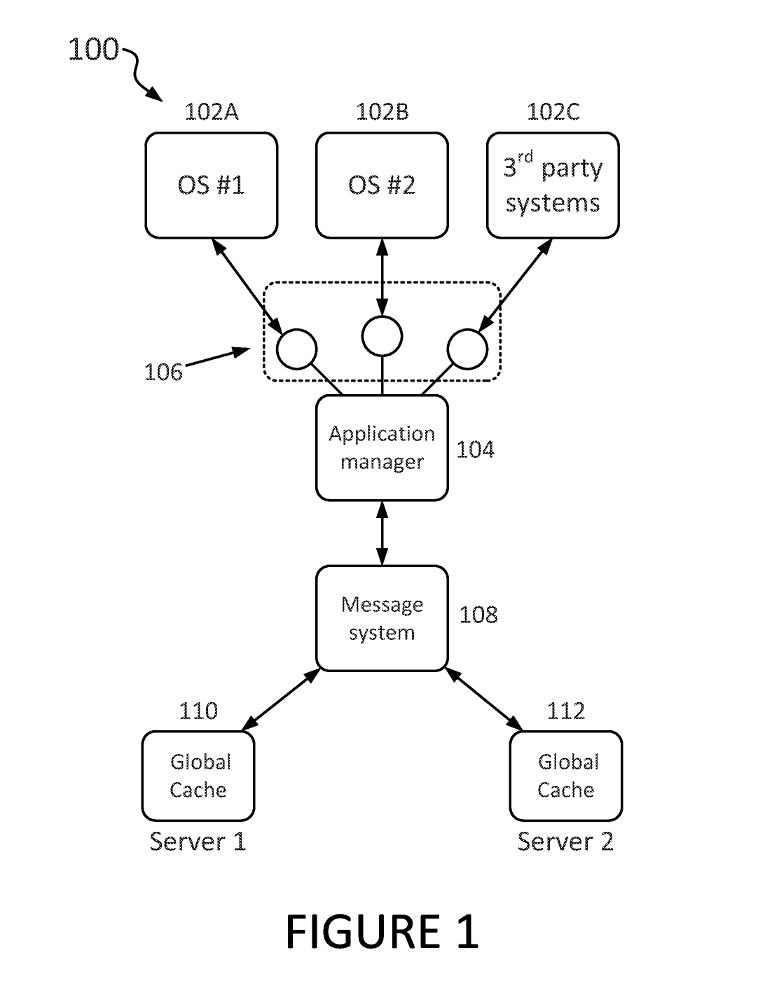

FIG. 1 is an illustration of a computing environment detailing how information is stored and shared between operating systems according to one embodiment. The computing environment 100 may contain computer systems executing operating systems 102A, 102B, and 102C, an application manager 104, APIs 106, a message system 108, and global caches of automation variables 110 and 112. Each of the components 102A, 102B, 102C, 104, and 108 of computing environment 100 may contain one or more central processing units, processors, databases, user interfaces, random access memory (RAM), a read only memory (ROM), one or more system buses, a keyboard, a pointing device, a touch screen, an input/output (I/O) adapter, a communications adapter, a user interface adapter, a display adapter, and other computing components. The operating systems OS #1 102A and OS #2 102B may operate in a similar environment, such as Master Control Program (MCP) and OS2200 of UNISYS. In addition, operating systems 102 may include third party operating systems 102C that do not share a similar environment with systems 102A and 102B. In one embodiment, the computer systems executing operating systems 102A, 102B, and/or 102C may be virtualized and executing on one or more servers. The processing unit may include a server, a processor, a microprocessor, a graphics processing unit (GPU), a field programmable gate array (FPGA), and any other component configured to process data and compute instructions. The processing units of these operating systems may be configured to share information to each other through attribute change event reports.

The processing unit of application manager 104 may receive attribute change event reports from any of the operating systems 102A, 102B, and 102C through APIs 106 exposed by the application manager 104 to the operating systems 102A, 102B, and 102C. The APIs 106 may provide a uniform manner of providing reports to the application manager 104 through different operating systems 102A, 102B, and 102C. The attribute change event reports may indicate a value of the attribute change for all attribute change requests, a name of an object referenced in the report, an object type, a source of the particular event, a unique trait about the source of the particular event, and the like. In one embodiment, the attribute change event report may include a request for information from one operating system to another operating system. The application manager 104 may be configured to transfer information, such as variables, variable names, and variable states to other operating systems based on the report. The application manager 104 may be a Shared Object manager Application (SOMA) or any application manager that performs the functions of application manager 104. In addition, the application manager 104 may be configured to pass data and information from the attribute change event report to a message system 108 through generating a message event report.

In one embodiment, the message system 108 may be configured to parse message event reports and store variables and variable's most recent states in global caches of automation variables 110 and 112. In a different embodiment, the message system 108 may be configured to parse the message event report and instruct any of the operating systems 102A, 102B, and 102C or the application manager 104 to store variables and their most recent states in global caches 110 and 112. The message system may be a UNISYS Single Point Auto-action Message System (SP-AMS) or any message system that performs the functions of message system 108. For example, the message system 108 may be configured to receive a message event report with an instruction to store variable Y and its most recent state, the value ID2803, from OS #1 102A in global cache 110. This variable may be regularly accessed by a third party system 102C to perform some function required by third party system 102C. If operating system OS #1 102A experiences a reboot or a failure, the variable Y and its most recent state, the value ID2803, may be accessed by the third party system 102C from global cache 110.

In one embodiment, the global cache 110 may be duplicated in part or in whole in a secondary global cache 112. Global cache 110 may function as a primary cache for variable and variable state storage, while global cache 112 may be a secondary cache that acts as a backup cache for variables and variable states stored in global cache 110. The global caches 110 and 112 may contain their own processing units, processors, databases, memory units, or other computing components as necessary for its operation. The global caches 110 and 112 may reside on independent servers 1 and 2, respectively, or may reside on a single server. In one embodiment, if the global caches 110 and 112 reside on different servers, separate application managers may be installed on each server to interact with the associated global cache residing on that server.

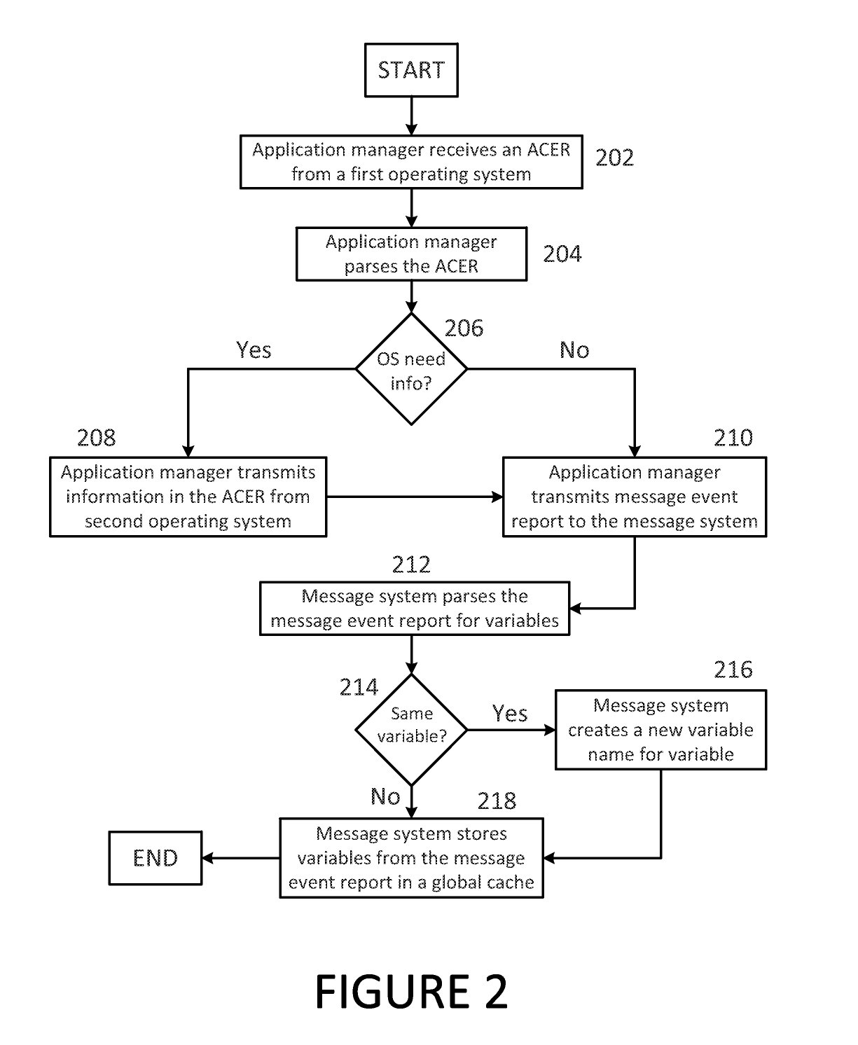

FIG. 2 is a flowchart illustrating a method of saving variables in a global cache according to one embodiment. The method begins at step 202 where the application manager may be configured to receive an attribute change event report (ACER) from a first operating system. The first computing may be any of the operating systems 102A, 102B, 102C, or the like. In step 204, the application manager 104 may be configured to parse the attribute change event report. The step of parsing the attribute change event report may include scanning the report or modifying the report into a readable format for another operating system. After the attribute change event report is parsed, at step 206, the application manager 104 may be configured to determine if the first operating system needs to access any information directly from the attribute change event report. If the determination is “Yes,” the application manager 104 may be configured to transmit information from the attribute change event report to a second operating system at step 208. The second operating system may be any of the operating systems 102A, 102B, 102C, or the like different than the first operating system. Following step 208, the application manager 104 may be configured to transmit a message event report to the message system 108 at step 210. If the determination at step 206 is “No,” step 208 may be bypassed and the application manager 104 may be configured to transmit a message event report to the message system 108 at step 210. The message event report may contain all or a part of the information included in the attribute change event report. The message event report may also contain information different than the information included in the attribute change event report.

When the message event report is received at the message system 108, the message system 108 may be configured to parse the message event report for variables and variable states at step 212. The step of parsing the message event report may include scanning the report, analyzing any existing variables in the global cache, and/or modifying the report into a readable format for one or more operating systems. Parsing of the message event report may be based on an established set of parsing rules. At step 214, a determination may be made at the message system 108 as to whether the same variable name exists for more than one operating system. Sometimes, operating systems may utilize the same variable name for functions associated with their particular operating system. As a result, one or more message event report received at the message system 108 may contain the variable COUNTER with value 200 from one operating system and the variable COUNTER with value 78 from another operating system.

If it is determined at the message system 108 that a variable name in multiple event reports or in a global cache is shared by more than one operating system (a “Yes” response at step 214), the message system 108 may be configured to create distinct variable names to distinguish the operating systems' variables from each other at step 216. After creating the distinct variable names, the message system 108 may be configured to store variables and their most recent states from the message event report in a global cache at step 218. If it is determined that variable names in the global cache or in message event reports are unique, step 216 may be bypassed and the message system 108 may be configured to store variables and their most recent states from the message event report in a global cache 110 at step 218. Global cache 110 may serve as the primary global cache for storing variables. In one embodiment, the variables may also be stored in global cache 112 which serves as a secondary or backup global cache for automation variables. Additionally, the variables may be stored automatically in the secondary global cache 112 after they are stored in the primary global cache 110. After step 218, the method terminates or may wait for another ACER to be received at execute again starting at step 202.

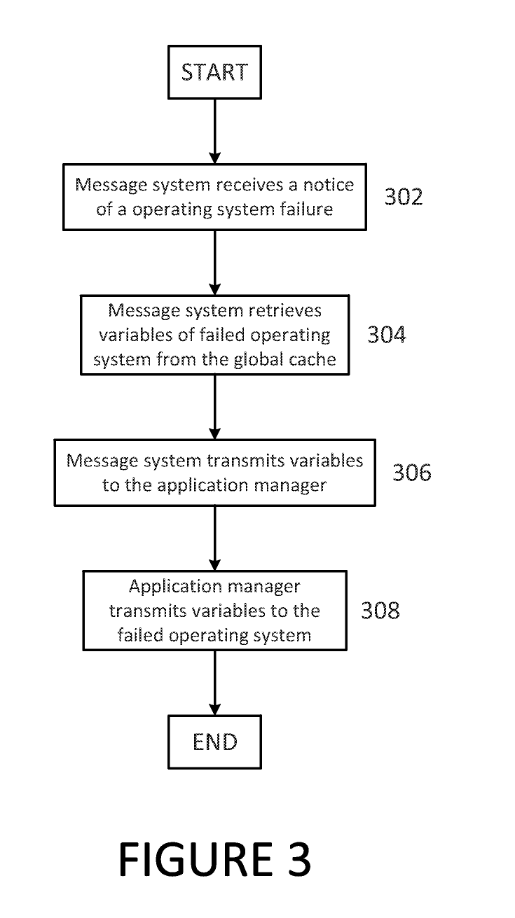

FIG. 3 is a flowchart illustrating a method of retrieving variables from a global cache in response to a system failure according to one embodiment. The method begins at step 302 where a notice of an operating system is received at the message system 108. The notice may be a message event report transmitted to the message system 108 from the application manager 104 or the notice may be received from operating system directly. In addition, the notice may be a request to retrieve variables and their most recent states that were lost in the system failure or reboot. At step 304, the message system may be configured to retrieve those variables from the global cache. In one embodiment, the variables may be retrieved from either the primary global cache 110 or the secondary global cache 112. If the primary global cache 110 is unavailable for use for any reason, the variables may be retrieved from the secondary global cache 112. Using multiple global caches may remove threats of failure to any server that contains a global cache.

At step 306, the message system 108 may be configured to transmit the retrieved variables, retrieved variable states, and or any information associated to the variables to the application manager 104. In one embodiment, the transmission of the retrieved variables and retrieved variable states from the message system 108 to the application manager 104 may exist in the form of a message event report. At step 308, the application manager 104 may be configured to transmit the retrieved variables, retrieved variable states, and or any information associated to the variables to the failed or rebooted operating system. After step 308, the method terminates or may return to step 302 when another failure notice is received. In another embodiment, the transmission of the retrieved variables and retrieved variable states from the application manager 104 to the failed or rebooted operating system may exist in the form of an attribute change event report. Moreover, the retrieved variables and retrieved variable states may be transmitted directly from the message system 108 to the failed or rebooted operating system. It is noted that a person of ordinary skill in the art may appreciate several alternative options for accessing and transmitting retrieved variables and retrieved variable states.

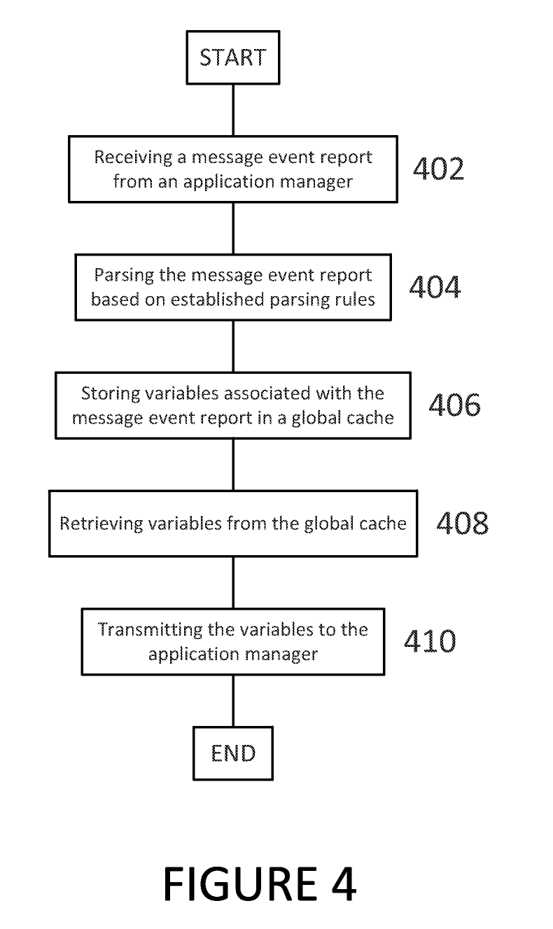

FIG. 4 illustrates a method of storing and retrieving variables by a message system according to one embodiment. The method starts at step 402 where a message system 108 may be configured to receive a message event report from an application manager 104. The message event report may contain information associated with operating system variables and variable states. At step 404, the message system 108 may be configured to parse the message event report based on an established set of parsing rules. The step of parsing the message event report may include scanning the report, analyzing any existing variables in the global cache, and/or modifying the report into a readable format for one or more operating systems. Examples of parsing messages with one or more parsing rules are further provided in U.S. Pat. No. 7,321,992, which is incorporated by reference herein. After the message event report is parsed, the message system 108 may be configured to store the variables and their most recent states associated with the message event report in a global cache for automation variables at step 406. The variables may be stored in the primary global cache 110 or the secondary or backup global cache 112. Additionally, the variables may be stored automatically in the secondary global cache 112 after they are stored in the primary global cache 110.

A notice may be transmitted to the message system 108 of an operating system reboot or failure. In response to this reboot or failure, the message system may be configured to retrieve variables and their most recent variable states from the primary global cache 110 or, if the primary global cache is unavailable, the secondary or backup global cache 112 at step 408. After retrieving the variables and their most recent variable states, the message system 108 may be configured to transmit the retrieved variables and retrieved variable states to the application manager 104 at step 410. When the application manager 104 receives the retrieved variables and retrieved variable states, the application manager may be configured to transmit the retrieved variables and retrieved variable states to the failed or rebooted operating system. In an alternate embodiment, the message system 108 may be configured to transmit the retrieved variables and retrieved variable states to the failed or rebooted operating system directly. After step 410, the method terminates.

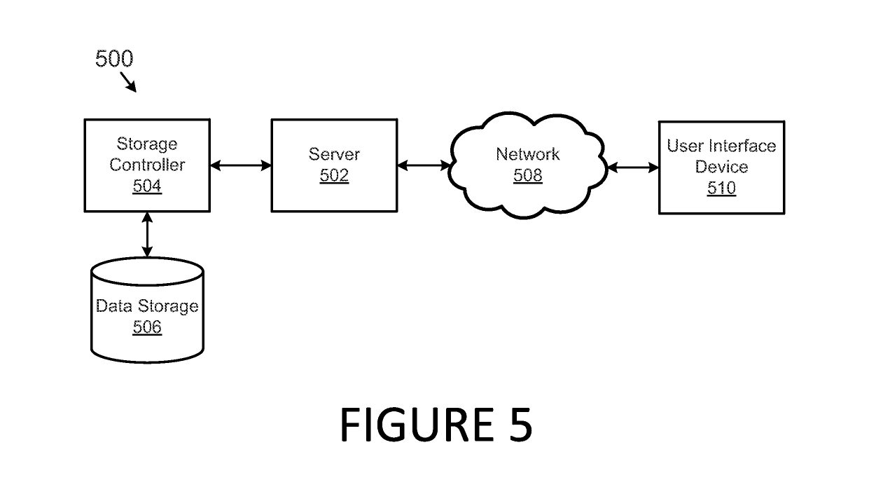

FIG. 5 illustrates one embodiment of a system for transferring information, including a system for establishing a global cache according to one embodiment. The system 500 may include a server 502, a data storage device 506, a network 508, and a user interface device 510. In a further embodiment, the system 500 may include a storage controller 504, or storage server configured to manage data communications between the data storage device 506 and the server 502 or other components in communication with the network 508. In an alternative embodiment, the storage controller 504 may be coupled to the network 508. The system 500 may support analysis by hosting caches 110 and/or 112 of FIG. 1 on the computing system 100.

In one embodiment, the user interface device 510 is referred to broadly and is intended to encompass a suitable processor-based device such as a desktop computer, a laptop computer, a personal digital assistant (PDA) or tablet computer, a smartphone, or other mobile communication device having access to the network 508. In a further embodiment, the user interface device 510 may access the Internet or other wide area or local area network to access a web application or web service hosted by the server 502 and may provide a user interface for communicating with the operating systems 102A, 102B, and 102C, application manager 104, message system 108 and/or any of the caches 110 and 112 that may be controlled by separate processing units of FIG. 1.

The network 508 may facilitate communications of data between the server 502 and the user interface device 510. The network 508 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

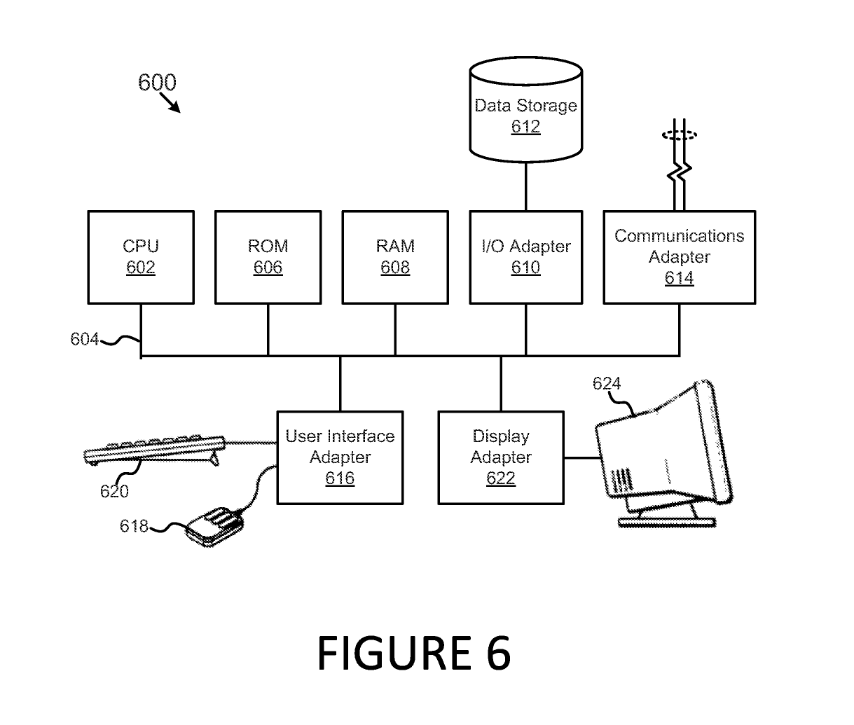

FIG. 6 illustrates a computer system adapted according to certain embodiments of the server and/or the user interface device. The central processing unit (“CPU”) 602 is coupled to the system bus 604. Although only a single CPU is shown, multiple CPUs may be present. The CPU 602 may be a general purpose CPU or microprocessor, graphics processing unit (“GPU”), and/or microcontroller. The present embodiments are not restricted by the architecture of the CPU 602 so long as the CPU 602, whether directly or indirectly, supports the operations as described herein. The CPU 602 may execute the various logical instructions according to the present embodiments.

The computer system 600 may also include random access memory (RAM) 608, which may be synchronous RAM (SRAM), dynamic RAM (DRAM), synchronous dynamic RAM (SDRAM), or the like. The computer system 600 may utilize RAM 608 to store the various data structures used by a software application. The computer system 600 may also include read only memory (ROM) 606 which may be PROM, EPROM, EEPROM, optical storage, or the like. The ROM may store configuration information for booting the computer system 600. The RAM 608 and the ROM 606 hold user and system data, and both the RAM 608 and the ROM 606 may be randomly accessed.

The computer system 600 may also include an input/output (I/O) adapter 610, a communications adapter 614, a user interface adapter 616, and a display adapter 622. The 1/O adapter 610 and/or the user interface adapter 616 may, in certain embodiments, enable a user to interact with the computer system 600. In a further embodiment, the display adapter 622 may display a graphical user interface (GUI) associated with a software or web-based application on a display device 624, such as a monitor or touch screen.

The I/O adapter 610 may couple one or more storage devices 612, such as one or more of a hard drive, a solid state storage device, a flash drive, a compact disc (CD) drive, a floppy disk drive, and a tape drive, to the computer system 600. According to one embodiment, the data storage 612 may be a separate server coupled to the computer system 600 through a network connection to the I/O adapter 610. The communications adapter 614 may be adapted to couple the computer system 600 to the network 608, which may be one or more of a LAN, WAN, and/or the Internet. The user interface adapter 616 couples user input devices, such as a keyboard 620, a pointing device 618, and/or a touch screen (not shown) to the computer system 600. The keyboard 620 may be an on-screen keyboard displayed on a touch panel. The display adapter 622 may be driven by the CPU 602 to control the display on the display device 624. Any of the devices 602-622 may be physical and/or logical.

The applications of the present disclosure are not limited to the architecture of computer system 600. Rather the computer system 600 is provided as an example of one type of computing device that may be adapted to perform the functions of the server 502 and/or the user interface device 510. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASICs), very large scale integrated (VLSI) circuits, or other circuitry. In fact, persons of ordinary skill in the art may utilize any number of suitable structures capable of executing logical operations according to the described embodiments. For example, the computer system may be virtualized for access by multiple users and/or applications.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media. Additionally, the firmware and/or software may be executed by processors integrated with components described above.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving, by a processor, one or more message event reports from an application manager through an application programming interface (API), wherein the one or more message event reports correspond to one or more computer systems of disparate types;
parsing, by the processor, the one or more message event reports in accordance with one or more parsing rules; and
storing, by the processor, one or more variables associated with the one or more operating systems in a global cache according to the one or more parsing rules.

2. The method of claim 1, further comprising, in response to a failure of one of the one or more computer systems, performing the steps comprising:
retrieving, by the processor, the one or more variables from the global cache; and
transmitting, by the processor, the one or more variables to the application manager, wherein the application manager is configured to transmit the one or more variables to the one or more failed operating systems.

3. The method of claim 1, wherein parsing the one or more message event reports comprises:
analyzing, by the processor, one or more existing variables in the global cache; and
modifying, by the processor, the one or more message event reports into a readable format for one or more computer systems.

4. The method of claim 1, further comprising storing, by the processor, the one or more variables associated with the one or more computer systems in a secondary global cache.

5. The method of claim 1, further comprising receiving, by the processor, a request to retrieve variables and their most recent states that were lost in the failure of one of the one or more computer systems.

6. An apparatus, comprising:
a processor; and
a memory coupled to the processor, wherein the processor is configured to perform the steps of:
receiving one or more message event reports from an application manager through an application programming interface (API), wherein the one or more message event reports correspond to one or more computer systems of disparate types;
parsing the one or more message event reports in accordance with one or more parsing rules; and
storing one or more variables associated with the one or more operating systems in a global cache.

7. The apparatus of claim 6, wherein the processor is further configured to, in response to a failure of one of the one or more computer systems, execute the steps comprising:
retrieving the one or more variables a from the global cache; and
transmitting the one or more variables to the application manager, wherein the application manager is configured to transmit the one or more variables to the one or more failed operating systems.

8. The apparatus of claim 6, wherein the processor being configured to perform the step of parsing the one or more message event reports may comprise the processor being further configured to perform the steps of:
analyzing one or more existing variables in the global cache; and
modifying the one or more message event reports into a readable format for one or more operating systems.

9. The apparatus of claim 6, wherein the processor is further configured to perform the step of storing the one or more variables associated with the one or more computing systems in a secondary global cache.

10. The apparatus of claim 6, wherein the processor is further configured to perform the step of receiving a request to retrieve variables that were lost in the failure of one of the one or more computing systems.

11. A computer program product, comprising:
a non-transitory computer readable medium comprising instructions which, when executed by a processor of a computing system, cause the processor to:
receive one or more message event reports from an application manager through an application programming interface (API), wherein the one or more message event reports correspond to one or more computer systems of disparate types;
parse the one or more message event reports in accordance with one or more parsing rules; and
store one or more variables associated with the one or more operating systems in a global cache according to the one or more parsing rules.

12. The computer program product of claim 11, in which the medium further comprises instruction which cause the processor to, in response to a failure of one of the one or more computer systems, execute the steps comprising:
retrieve the one or more variables from the global cache; and
transmit the one or more variables to the application manager, wherein the application manager is configured to transmit the one or more variables to the one or more failed computer systems.

13. The computer program product of claim 11, wherein the non-transitory computer readable medium comprising instructions which, when executed by the processor of the computing system, cause the processor to parse the one or more message event reports may further comprise instructions which, when executed by the processor of the computing system, cause the processor to:
analyze one or more existing variables in the global cache; and
modify the one or more message event reports into a readable format for one or more computer systems.

14. The computer program product of claim 11, wherein the non-transitory computer readable medium further comprises instructions which, when executed by the processor of the computing system, cause the processor to store the one or more variables associated with the one or more computer systems in a secondary global cache.

15. The computer program product of claim 11, wherein the non-transitory computer readable medium further comprises instructions which, when executed by the processor of the computing system, cause the processor to receive a request to retrieve variables that were lost in the failure of one of the one or more computer systems.
